(19) United States
(12) Patent Application Publication
(10) Pub. No.: US 2025/0324505 A1
(43) Pub. Date: Oct. 16, 2025

(54) MICROWAVE-CYCLOTRON-RESONANCE PLASMA THRUSTER AND ASSOCIATED OPERATING METHOD, AND USE

(71) Applicant: Christian-Albrechts-Universitaet zu Kiel, Kiel (DE)

(72) Inventors: Alexander Spethmann, Kronshagen (DE); Thomas Trottenberg, Kiel (DE); Holger Kersten, Molfsee (DE)

(21) Appl. No.: 18/866,510

(22) PCT Filed: May 11, 2023
(86) PCT No.: PCT/DE2023/100346

§ 371 Date: Nov. 15, 2024

(30) Foreign Application Priority Data
May 17, 2022 (DE) 10 2022 112 292.1

(51) Int. Cl. H05H 1/18; F03H 1/00; H05H 1/46

(52) U.S. Cl. CPC H05H 1/18; F03H 1/0056; H05H 1/461

(57) ABSTRACT

A microwave-cyclotron-resonance plasma thruster including a permanent-magnet stack, a coaxial electrode array, an anode and a cathode, wherein: the permanent-magnet stack includes at least one permanent magnet, the at least one permanent magnet being annular and having a magnetisation in the axial direction; the coaxial electrode array has an inner coaxial conductor and an outer coaxial conductor; and the thruster is semiconductor-based and cylindrical, the inner cross-sectional surface area being circular or elliptical or circular-like. Also, an operating method for operating the microwave-cyclotron-resonance plasma thruster.

A microwave cyclotron resonance plasma thruster comprising a permanent magnet stack, a coaxial electrode assembly, an anode and a cathode, wherein the permanent magnet stack includes at least one permanent magnet, the at least one permanent magnet being ring-shaped and having magnetization in the axial direction; the coaxial electrode arrangement has an inner coaxial conductor and an outer coaxial conductor, the engine is semiconductor-based and cylindrical, the inner cross-sectional area being circular or elliptical or similar to a circle.

Furthermore, the invention relates to an operating method for operating a microwave cyclotron resonance plasma thruster according to the invention. The invention also relates to a use.

Nowadays, the use of small transmitters and receivers in the microwave frequency range is suitable for mass use in telecommunications. Robust generation of plasmas is possible with microwave sources. Such microwave-generated plasmas are used in a variety of ways in plasma process technology. Typical applications include etching and coating of solid surfaces, waste gas purification or even use in the medical field. In recent years, miniaturized microwave plasma sources that allow for relatively easy handling have increasingly come onto the market.

Microwave technology in particular has seen rapid development in recent decades. While klystrons, magnetrons and traveling wave tubes were previously used exclusively for microwave generation, it is becoming apparent that these will be replaced by semiconductor technology in the higher power range in the future.

Plasma jets for atmospheric pressure conditions are now also being sold with semiconductor-based GHz electronics that generate the microwaves.

Plasma sources that generate plasmas with microwave frequencies are currently used commercially primarily for materials processing purposes.

The Japanese Hayabusa mission is known from the state of the art, in which traveling wave tubes were used to generate microwaves for grid ion thrusters. The microwaves were used here for both the main plasma and the smaller plasma of the neutralizer, which is a useful option for generating a microwave plasma.

In particular, however, subsequent publications concerning vacuum-compatible plasma-utilizing thrusters are known that are designed for use in space, for example.

HEMP thrusters known from the prior art have a stack of permanent magnet rings arranged with opposite magnetic polarity in adjacent magnets, so that the static magnetic field formed is weak on the axis of symmetry and also has field-free points, while it has a strong radial field component towards the magnets. The electric field is essentially aligned axially and is used both for plasma generation and for accelerating the ions. The arrangement of strong magnets with opposite polarity in close proximity requires considerable forces and a secure locking mechanism.

CN 104234957 A discloses a device for ensuring this locking mechanism of the oppositely poled strong magnets in a HEMP thruster.

In addition, CN 113309680 A describes that permanent magnets are limited in terms of the achievable magnetic fields, which also limits the efficiency of plasma generation and thrust. CN 113309680 A discloses magnetic field generation by means of two coils arranged one inside the other, which generate opposing magnetic fields. Radially directed magnetic field components form between the widely spaced coil windings.

From CN 109681398 A and U.S. Pat. No. 7,493,869 B1, plasma generation using the electron cyclotron resonance effect (ECR effect) and permanent magnets is also known.

U.S. Pat. No. 7,493,869 B1 discloses the generation of a relatively large, dense and uniform plasma with subsequent guidance onto a workpiece to enhance material processing.

In “Development of Microwave Discharge Engine System for Asteroid Sample and Return Mission Muses-C”, The Journal of Space Technology and Science, 1997, Volume 13, Issue 1, Pages 1_26-1_34, Funaki, Kuninaka et al. describe an ion thruster system in the 1 kW class for asteroid sample collection and return. The designed thruster has a secondary microwave discharge that does not cause degradation of a thermionic cathode, as used in conventional ion thrusters, enabling the very long lifetime required for the sample collection and return mission. In the ion thruster head, microwave power is converted from a coaxial line into a circular cross-section waveguide and directed into the main discharge chamber, which has circularly arranged magnets or ring magnets. The electron cyclotron resonance layer, where most of the plasma generation is to take place, is located above the magnets, from which the generated ions diffuse and are then extracted by an accelerating grid. Regarding the microwave neutralizer, the microwaves are introduced into the discharge chamber via an L-shaped antenna.

In addition, Kuninaka, Nishiyama et al. in “Status of Microwave Discharge Ion Engines on Hayabusa Spacecraft”, AIAA 2007-5196, 43rd AIAA/ASME/SAE/ASEE Joint Propulsion Conference & Exhibit, reveal cathodeless electron cyclotron resonance ion engines used in a spacecraft. These have the following technological features:
Xenon ions are generated by electron cyclotron resonance microwave discharge;
neutralizers are operated by electron cyclotron resonance microwave discharge;
a single microwave generator simultaneously feeds the ion generator and the neutralizer;
3 DC power supplies for ion acceleration;
the electrostatic grid system is made of a carbon-carbon composite with a stable distance between the grids.

In particular, CN 109681398 A describes a drive unit for space propulsion with the most efficient plasma generation possible, for which various ionization regions are provided through which the neutral gas flows. The design of the drive unit is complex.

The problems with the prior art are essentially that existing electron cyclotron resonance (ECR) thrusters do not use semiconductor generators and also require a grid system consisting of at least three grids. The use of grid systems is complex and, in addition, these can be eroded.

The realization of the electron cyclotron resonance effect (EZR effect) with the help of permanent magnets is known from the literature. However, only complex arrangements for use in a thruster in space, i.e., under vacuum, as in the publication CN 109681398 A, are known so far.

The present invention is based on the objective of providing a thruster in which a plasma can be generated in a vacuum environment by means of microwaves in a simple manner, without a complex system structure. The generation of plasma by means of microwaves is to be carried out with the help of semiconductor technology.

This task is solved by means of a microwave cyclotron resonance plasma thruster according to the main claim and a method for operating the microwave cyclotron resonance plasma thruster according to the secondary claim.

A microwave cyclotron resonance plasma thruster comprising a permanent magnet stack, a coaxial electrode assembly, an anode, and a cathode, wherein
the permanent magnet stack includes at least one permanent magnet, the at least one permanent magnet being ring-shaped and having magnetization in an axial direction;
the coaxial electrode arrangement has an inner coaxial conductor and an outer coaxial conductor;
the thruster is semiconductor-based and cylindrical, with the inner cross-sectional area being circular or elliptical or similar to a circle (e.g. also square or polygonal or similar); and wherein the thruster is characterized in that
the permanent magnet stack is spatially arranged in the length beyond the coaxial electrode arrangement;
the inner coaxial conductor is formed so as to project beyond the outer coaxial conductor in a defined length interval [zc1, zc2];
the cathode has a high transparency;
the anode does not extend spatially into the coaxial conductor and is arranged downstream of the coaxial conductor in the direction of flow;
the permanent magnets all have the same magnetization in the axial direction;
a microwave generator is electrically isolated from the generated plasma;
exactly one ionization zone and exactly one acceleration zone are provided, these being arranged spatially and electrically in succession and merging into one another;
whereby in use
a microwave field is formed or can be formed between the outer coaxial conductor potential and the inner coaxial conductor potential;
the ionization zone is formed or can be formed near the inner coaxial conductor (3.1) or the central axis in the defined length interval [zc1, zc2];
the acceleration zone is formed spatially between anode and cathode;
in the ionization zone, an axial static magnetic field generated by the permanent magnet stack and a radial high-frequency electric field generated by the microwave field electric field with a resonance condition being fulfilled between the microwave and electron cyclotron frequency (ECR effect);
the path under the influence of the magnetic field is designed to be constructively short for ions formed in the ionization zone;
the magnetic field of the permanent magnet stack is designed to run in the direction of the magnets after the end of the magnetic field exposure direction of the magnets, so that free electrons are spatially bound to the magnetic field and free ions are not or only slightly influenced by the magnetic field.

A permanent magnet stack can comprise exactly four permanent magnets.

Preferably, the cathode can be formed as a grid or ring with high transparency. In the context of the invention, transparency refers to the proportion of ions that do not collide with the mechanical structure of the grid or ring but pass through it.

In particular, the microwaves can be in the range of 2.4 to 2.5 GHz and the magnetic field strength can have a value of 85.7 to 89.3 mT, so that the EZR effect is fulfilled.

In addition, the coaxial electrode arrangement can be designed to bisect the permanent magnet stack over its length.

The permanent magnet stack can be made of ferrite.

Preferably, all connections of the generated plasma to the generator of the thruster can be designed to be insulated by a ceramic and/or another dielectric.

The operating method according to the invention for operating the microwave cyclotron resonance plasma thruster according to the invention, whereby a thrust is generated during operation by ions emerging from the thruster, is characterized in that
a static magnetic field with a field strength for fulfilling the conditions of the ECR effect or the ECR conditions or to enable the ECR effect through the permanent magnet stack, whereby field lines of the magnetic flux density emerge at one end face of the permanent magnet stack and run back through the inner space enclosed by the permanent magnet stack to the other end face of the permanent magnet stack;
a high-frequency alternating voltage with a frequency for generating a radial electric field between the inner coaxial conductor and the outer coaxial conductor to fulfill the conditions of the ECR effect and the ECR conditions, respectively the ECR conditions or is applied to enable the ECR effect;
an electrically neutral gas is fed into the microwave cyclotron resonance plasma thruster via a gas inlet;
the gas flows along the coaxial conductor;
plasma formation/ionization takes place in the length interval [zc1, zc2] due to the fulfilled resonance condition between microwave and electron cyclotron frequency (ECR effect);
the plasma formed propagates towards the anode, whereby
   free electrons are drawn off by the magnetic field running towards the magnets after the end of the magnetic field effect and
   free ions pass through the anode, are electrostatically accelerated in the area between the anode and cathode and exit the system through the cathode.

The coaxial conductor can be designed to be insulated.

Furthermore, free electrons from the generation region can be reflected back into the ionization zone by the magnetic field running in the direction of the end faces of the magnets.

Furthermore, the use of the microwave cyclotron resonance plasma thruster and/or the operating method according to the invention in a thruster or micro-thruster or small thruster for space travel is also according to the invention. It can be used as a maneuvering thruster in space travel, for example for repositioning and stabilizing satellites.

In general, semiconductor-based microwave plasmas are easy and efficient to generate, with little energy required. In addition, microwave plasmas are particularly easy to start and control.

In particular, in a coaxial microwave discharge, the power input is concentrated in a small volume, which is why very high degrees of ionization and power densities can be achieved, resulting in high mass efficiency when used in an electric thruster.

RIT (radiofrequency ion thrusters) and Kaufman ion sources require a much larger plasma-filled volume and suffer from greater losses due to the interaction of the plasma with the walls.

In contrast, the coaxial microwave design of the invention extracts ions from a small generation volume using relatively strong electric fields. Most of the plasma electrons are retained by the magnetic field.

Propulsion systems of this type are well known and are now in use. The basic principle is based on the ionization (plasma generation) of an on-board (electrically neutral) fuel with subsequent acceleration and ejection of the ions by an electrostatic field. The reaction accelerates the thruster and thus the body to which it is attached. Typical exit speeds of the ions are between 10 and 100 km/s, which is 1 to 2 orders of magnitude higher than the speeds achievable through chemical combustion. This means that even very small accelerated propellant masses generate a significant impulse and the propellant mass is used very efficiently.

When using the microwave cyclotron resonance plasma thruster, functionality is said to be given at a power between 20 W and 300 W, although powers of up to 1500 W are possible. In contrast to this, when low thrusts (e.g., for attitude control) are requested, a high power is still required to generate the plasma in RIT, HEMPT and Hall thrusters.

The microwave cyclotron resonance plasma thruster with plasma generation by the ECR effect in a permanent magnetic field has a combination of the following distinguishing features compared to the prior art:
the system is cylindrical and rotationally symmetrical;
the ionization zone is located near the central axis in a defined length interval [zc1, zc2];
an axial magnetic field and a radial electric field with the EZR frequency;
an electrostatic acceleration zone is spatially separated from the ionization zone, with the distance between the two zones being small so that the ions generated only have to travel a short distance under the influence of the magnetic field;
the free electrons are guided by field lines reversing in the direction of the magnets and possibly reflected back into the ionization zone, and
the dynamic electric field is generated by a coaxial conductor with a protruding core, whereby the supplied neutral gas flows past the galvanically separated coaxial conductor and unaffected by fields, into the ionization zone.

This is a combination of an ECR microwave plasma source realization with the help of permanent magnets and accelerating electrodes, which makes it possible to realize an electric thruster for use in space.

The advantage of the traveling wave tubes for generating microwaves for grid ion engines in the aforementioned Japanese Hayabusa mission was that the microwaves were used for both the main plasma and the smaller plasma for neutralization, which is a useful option for generating a microwave plasma, with the electrodes being designed to be potential-free with respect to satellites and each other.

This advantage can be used in the same way for a microwave cyclotron resonance plasma thruster, which is an advantage over alternative GIT concepts (RF or DC) that require their own power supplies for the neutralizers.

The semiconductor technology used in this invention to create the thruster has some advantages over traveling wave tubes, including lower mass, a rugged and compact design, and straightforward impedance matching using variable frequency.

In the following, the invention is described on the basis of the accompanying figures in the figure description, whereby these are intended to explain the invention and are not necessarily to be considered restrictive:

The following show:

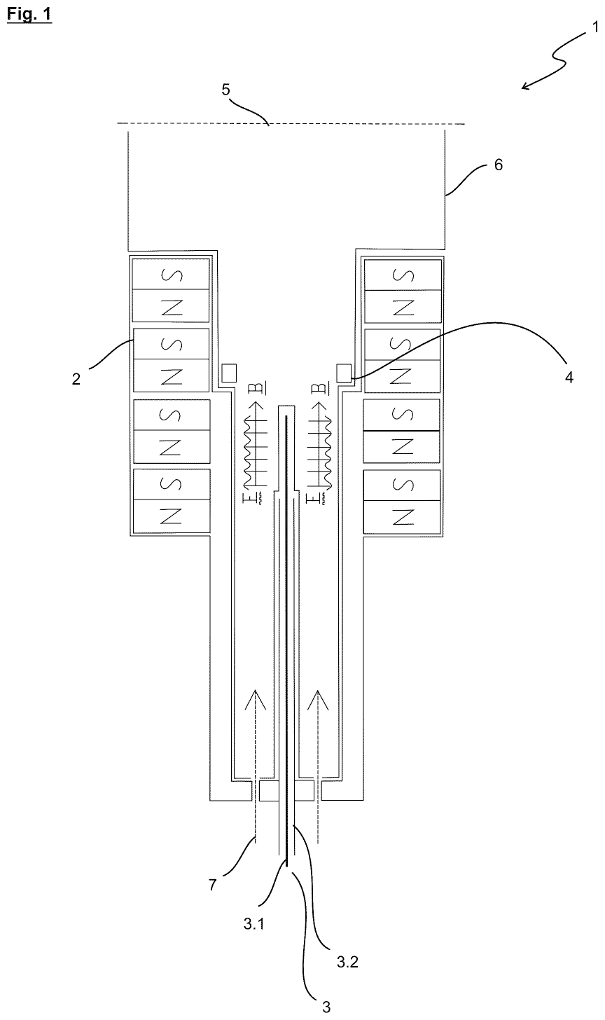

FIG. 1 a schematic representation of an embodiment of a microwave cyclotron resonance plasma thruster according to the invention;

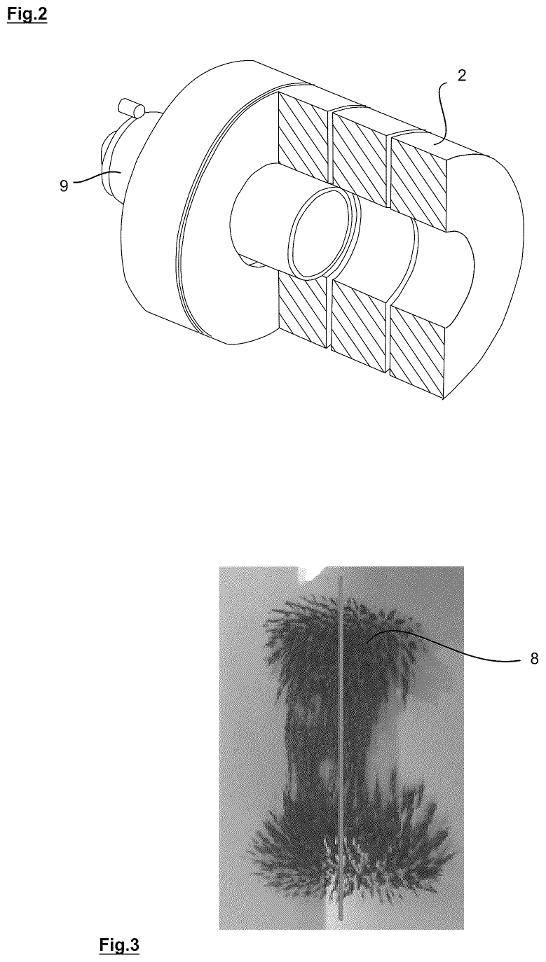

FIG. 2 an exemplary representation of an experimental combination of a microwave plasma source with a permanent magnet stack;

FIG. 3 an exemplary photographic visualization of field lines in an outer tangential plane at a cylindrical permanent magnet stack with iron filings;

FIG. 4 an exemplary representation of the magnetic field from FIG. 3 simulated with FEM;

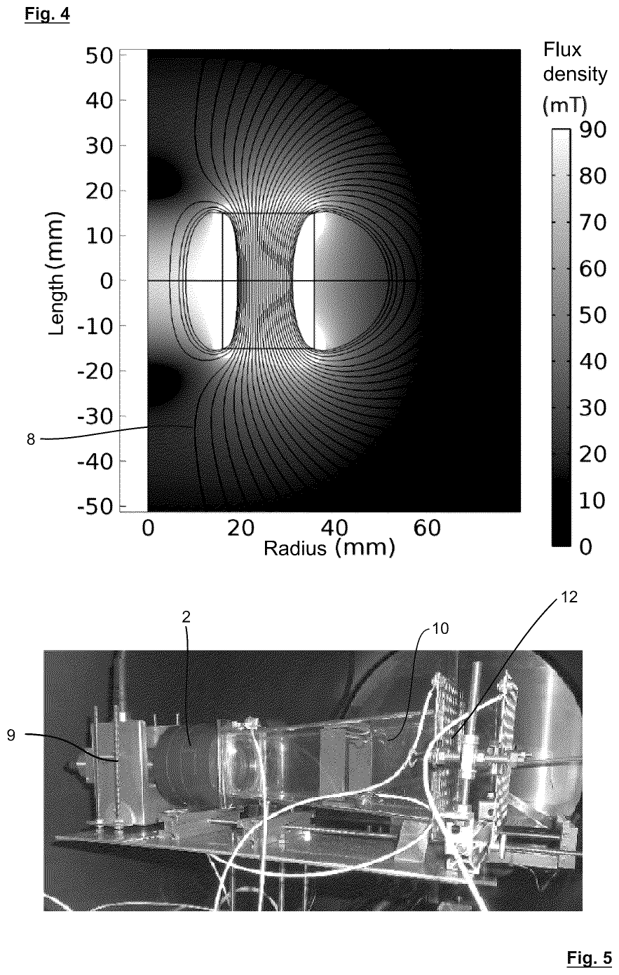

FIG. 5 an exemplary representation of an experimental test setup to examine plasma generation in the arrangement according to FIG. 2;

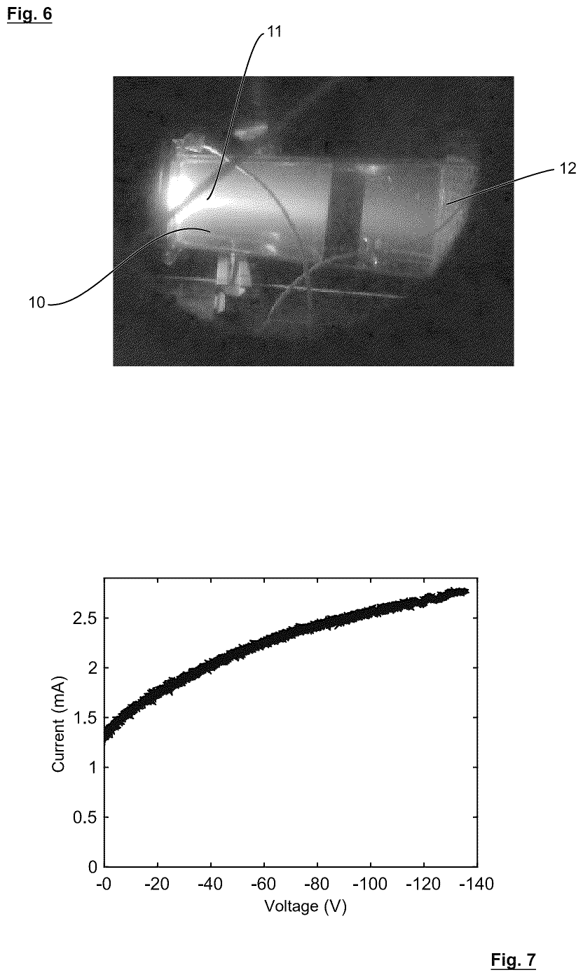

FIG. 6 an exemplary representation of a section of the experimental test setup from FIG. 5 in which the light emission of the generated plasma can also be seen and

FIG. 7 an exemplary representation of the extracted current as a function of the accelerating voltage at the plate electrodes and grids.

In FIG. 1, a schematic representation of an embodiment of a microwave cyclotron resonance plasma (MCP) thruster 1 according to the invention is shown. The MCP thruster 1 comprises a permanent magnet stack 2, an anode 4, a cathode 5, an insulating ceramic 3 and a coaxial electrode arrangement. The coaxial electrode arrangement comprises an inner coaxial conductor 3.1 and an outer coaxial conductor 3.2. A neutral gas, for example a noble gas, flows through the thruster via a gas inlet 7 and leaves it again via the cathode 5. The permanent magnets of the permanent magnet stack 2 all have the same magnetization direction. All connections to the generator of the MCP engine 1 are electrically isolated by the ceramic 6. For reasons of presentation, the generator is not shown in the figure.

The MCP engine 1 is cylindrical, which means it can be represented in cylindrical coordinates R, z, ϕ, where the z-axis in the figure runs vertically from bottom to top. In this example, rotational symmetry is assumed, i.e. independence of the azimuth angle ϕ. In principle, a non-rotationally symmetric cross-section is also possible. A cross-sectional deformation of the circle should not be excluded.

A neutral gas is used as fuel here, which flows from the gas inlet at z=0 past a coaxial conductor in the positive z-direction. An alternating voltage of 2.45 GHz is applied between the inner coaxial conductor (core) 3.1 and the outer coaxial conductor (shielding) 3.2. At z=zc1>0, the shielding 3.2 ends and the core 3.1 extends beyond the shielding 3.2 up to z=zc2>zc1. Predominantly in the interval [zc1, zc2], a high-frequency electric field E of the minimum order of magnitude kV/m enters the gas-conducting space, with the field near the core 3.1 having only a radial component (R direction). In the same interval, a static magnetic field is present due to a permanent magnet stack 2 (i.e., an arrangement of ring-shaped permanent magnets), which has only a z-component near the axis of symmetry (z-axis, inner coaxial conductor 3.1). At a magnetic flux density of about 87.5 mT at 2.45 GHz, the conditions for electron cyclotron resonance are fulfilled in the vicinity of the exposed core 3.1, i.e., the free electrons can resonantly absorb energy from the electric field and ionization occurs. Free electrons will then follow the magnetic field and are partially reflected in front of the end faces. The much heavier ions move only slightly influenced by the magnetic field over the interval [zc1, zc2]. Finally, at z=zA, they pass through a ring-shaped anode 4 at a positive potential with respect to the cathode 5, which forms the exit grid at z=zG, and are electrostatically accelerated in the interval [zA, zG]. The anode 4 is spatially arranged so that it does not extend into the coaxial conductor 3, as this would prevent the formation of the electric field E. The ions passing through the cathode 5 provide the thrust for the MCP thruster 1. The cathode 5 has a high transparency and is preferably designed as a grid or ring.

The ionization zone [zc1, zc2] and the acceleration zone [zA, zG] are arranged spatially and electrically in succession. The magnetic field is present in both zones, but acts in an enclosing manner on the free electrons in the acceleration zone. At the ends of the cylinder, the magnetic field lines run into the permanent magnet stacks 2. The higher flux density in front of the end faces can lead to a mirror effect in which the electrons are reflected in the opposite direction and possibly return to the ionization interval. An increase in the free electron density there increases the energy absorption from the microwave field and promotes plasma generation.

The MCP thruster 1 according to the invention is designed as a small thruster, so that the permanent magnet rings of the permanent magnet stack 2 have an inner diameter of only a few centimeters.

FIG. 2 shows an example of a test combination of a microwave plasma source with a permanent magnet stack 2. In the example shown in this figure, the permanent magnet stack 2 is formed by 4 ferrite permanent magnets. The microwave electrodes 9 are arranged bisecting the permanent magnet stack 2. The assembly is subjected to vacuum. When operating with microwaves of 2.4 to 2.5 GHZ, the EZR effect takes place in the entire inner cylindrical free area of the assembly.

FIG. 3 shows an example of a photographic visualization of field lines 8 in an outer tangential plane of a cylindrical permanent magnet stack 2 with iron filings, where the plane touches the magnets at the indicated line.

FIG. 4 shows an example of the magnetic field from FIG. 3 with FEM (finite element) simulation.

On the basis of FIGS. 3 and 4, it becomes clear that the magnetic field has reversing field lines 8. Electrons are held back by these field lines 8, which condense in front of the end faces. The screen grid, which is normally necessary for grid-driven engines, i.e., the first grid of several grids arranged one behind the other, can be dispensed with because the magnetic field with the reversing field lines 8 takes over its function. The magnetic field only retains electrons. Ions have too large gyration radii and are not deflected by the magnetic field.

In FIG. 5 an example of an experimental test setup for checking the plasma generation in the arrangement according to FIG. 2 is shown. The permanent magnet stack 2 is formed by 4 ferrite permanent magnets, which have an inner diameter of 32 mm, an outer diameter of 72 mm, a stack length of 60 mm and form a homogeneous or approximately homogeneous field inside with 87 mT. Following the experimental combination of microwave electrodes 9 and permanent magnet stacks 2 according to FIG. 2, a plasma expansion chamber/extraction chamber 10 made of glass is connected to the magnets.

The elongated glass extraction chamber 10 is used to visualize the plasma 11 leaving the inventive setup. A grid 12 limits the glass body and is used to measure the current of ions from the plasma 11. The ions are extracted from the plasma 11 by a bias voltage and measured as a current flowing through the perforated plate 12.

In addition, FIG. 6 shows an example of a section of the experimental test setup from FIG. 5 during operation, in which the light emission of the generated plasma can also be seen.

In FIG. 7, an example of the extracted current measured with the test setup from FIG. 5 is shown as a function of the accelerating voltage at the plate electrodes and grids 12. At a gas flow of argon under vacuum conditions (p=0.025 Pa) and a bias voltage of −120 V, an ion current of about 2.7 mA can be extracted.

### LIST OF REFERENCE SYMBOLS

1 Microwave cyclotron resonance plasma thruster (also MCP thruster for short)
2 Permanent magnet stack
3 Coaxial conductor
3.1 Inner coaxial conductor/core
3.2 Outer coaxial conductor/shielding
4 Anode
5 Cathode
6 Ceramic
7 Gas inlet
8 Field lines
9 Microwave electrodes
10 Plasma expansion chamber/extraction chamber
11 Plasma
12 Grid/perforated plate

1. A microwave cyclotron resonance plasma thruster (1) comprising a permanent magnet stack (2), a coaxial electrode arrangement, an anode (4) and a cathode (5), wherein
the permanent magnet stack (2) comprises at least one permanent magnet, the at least one permanent magnet being ring-shaped and having a magnetization in the axial direction;
the coaxial electrode arrangement having an inner coaxial conductor (3.1) and an outer coaxial conductor (3.2);
the thruster (1) is semiconductor-based and cylindrical, the inner cross-sectional area being circular or elliptical or similar to a circle;
wherein
the permanent magnet stack (2) is arranged spatially in the length beyond the coaxial electrode arrangement;
the inner coaxial conductor (3.1) projects beyond the outer coaxial conductor (3.2) over a defined length interval [zc1, zc2];
the cathode (5) has a high transparency;
the anode (4) does not extend spatially into the coaxial conductor (3) and is arranged downstream of the coaxial conductor (3) in the direction of flow;
the permanent magnets all have the same magnetization direction in the axial direction;
a microwave generator is galvanically isolated from the generated plasma;
exactly one ionization zone and exactly one acceleration zone are provided, these being arranged spatially and electrically in succession and merging into one another;
whereby in operation
a microwave field can be formed between the outer coaxial conductor potential and the inner coaxial conductor potential;
the ionization zone can be formed near the inner coaxial conductor (3.1) in the defined length interval [zc1, zc2];
the acceleration zone is formed spatially between the anode (4) and the cathode (5);
in the ionization zone, an axial static magnetic field generated by the permanent magnet stack (2) and a radial high-frequency electric field generated by the microwave field with the resonance condition between the microwave and electron cyclotron frequency being fulfilled are present;
the path under the influence of the magnetic field is constructively short for ions formed in the ionization zone;
the magnetic field of the permanent magnet stack (2) runs in the direction of the magnets after the end of the magnetic field influence, so that free electrons are spatially bound to the magnetic field and free ions are not influenced or only slightly influenced by the magnetic field.

2. The microwave cyclotron resonance plasma thruster (1) according to claim 1, wherein a permanent magnet stack (2) comprises exactly four permanent magnets.

3. The microwave cyclotron resonance plasma thruster (1) according to claim 1, wherein the cathode (5) is formed as a grid or ring with high transparency.

4. The microwave cyclotron resonance plasma thruster (1) according to claim 1, wherein the microwaves are in the range of 2.4 to 2.5 GHz and the magnetic field strength has a value of 85.7 to 89.3 mT.

5. The microwave cyclotron resonance plasma thruster (1) according to claim 1, wherein the coaxial electrode arrangement bisects the permanent magnet stack (2) over its length.

6. The microwave cyclotron resonance plasma thruster (1) according to claim 1, wherein the permanent magnet stack (2) is formed from ferrite.

7. The microwave cyclotron resonance plasma thruster (1) according to claim 1, wherein all connections of the generated plasma to the thruster generator are insulated by at least one of a ceramic (6) and another dielectric.

8. A method of operating the microwave cyclotron resonance plasma thruster (1) according to claim 1, wherein a thrust is generated in operation by ions emerging from the thruster (1), wherein
a static magnetic field with a field strength for fulfilling the conditions of the EZR effect is present through the permanent magnet stack (2), wherein field lines (8) of the magnetic flux density emerge at one end face of the permanent magnet stack (2) and run back through the inner space enclosed by the permanent magnet stack (2) to the other end face of the permanent magnet stack (2);
an alternating voltage with a frequency for generating a radial electric field between the inner coaxial conductor (3.1) and the outer coaxial conductor (3.2) is applied to fulfill the conditions of the EZR effect;
an electrically neutral gas is supplied via a gas inlet (7) into the microwave cyclotron resonance plasma thruster (1);
the gas flows along the coaxial conductor (3);
plasma formation takes place in the length interval [zc1, zc2] due to the resonance condition being met between the microwave and electron cyclotron frequency;
the plasma formed propagates in the direction of the anode (4), wherein
free electrons are retained by the magnetic field after the end of the magnetic field exposure and
free ions pass through the anode (4), are electrostatically accelerated in the area between the anode (4) and cathode (5) and exit the system through the cathode (5).

9. The operating method according to claim 8, wherein free electrons are reflected back from the generation area into the ionization zone by the magnetic field running towards the end faces of the magnets.

10. A method for space travel comprising providing a microwave cyclotron resonance plasma thruster according to claim 1 to a space vehicle and propelling the vehicle with the thruster.
